(19) United States
(12) Patent Application Publication
(10) Pub. No.: US 2007/0019966 A1
(43) Pub. Date: Jan. 25, 2007

(54) Optical transceiver module and control method thereof

(75) Inventors: Chien-Shu Chiu, Taoyuan Hsien (TW); Chiung-Hung Wang, Taoyuan Hsien (TW); Yung-Yuan Cheng, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/407,205

(22) Filed: Apr. 20, 2006

(30) Foreign Application Priority Data
Jul. 22, 2005 (TW) 094124966

(51) Int. Cl. H04B 10/00

(52) U.S. Cl. 398/155

(57) ABSTRACT

An optical transceiver module for transmitting an optical signal includes a receiver, a clock data recovery circuit and a controller. The receiver receives the optical signal and converts the optical signal into an electric signal. The clock data recovery circuit receives the electric signal and recovers the clock and data of the electric signal. The controller is electrically connected with and monitors the clock data recovery circuit. Also, a control method of an optical transceiver module is provided.

This Non-provisional application claims priority under U.S.C. § 119(a) on Patent Application No(s). 094124966 filed in Taiwan, Republic of China on Jul. 22, 2005, the entire contents of which are hereby incorporated by reference.

### BACKGROUND OF THE INVENTION

1. Field of Invention

The present invention relates to a transceiver module and a control method thereof, and more particularly to an optical transceiver module and a control method thereof.

2. Related Art

Owing to the development on the technologies of manufacturing and signal processing, the data transfer rate through an optical fiber is greatly increasing.

As shown in FIG. 1, a conventional optical transceiver module 1 transmits data in serial. The optical transceiver module 1 includes a receiver 11, a transmitter 12 and a controller 13. The receiver 11 receives an optical signal 111 and converts the optical signal 111 into an electric signal 112. The controller 13 transmits the electric signal 112 to a host 2. Also, the controller 13 controls the transmitter 12 to receive a data signal 131 from the host 2, convert the electric signal to the optical signal, and then transmit the converted data signal 131.

However, the frequency of the optical signal 111 may be changed due to a variety of noises during the transmission. As the results, the receiver 11 cannot correctly recover the clock and data of the optical signal 111 or the electric signal 112. That is, the electric signal 112 cannot be correctly read or processed by the host 2 after the optical signal 111 is converted to the electric signal 112. This situation is occurred especially during high-frequency transmission.

It is thus imperative to provide an optical transceiver module and a control method thereof to accurately receive and process the optical signal, and recover the clock and data of the electric signal during high-frequency transmission.

### SUMMARY OF THE INVENTION

In view of the foregoing, the present invention provides an optical transceiver module and a control method thereof to accurately receive and process the optical signal, and recover the clock and data of the electric signal during high-frequency transmission.

To achieve the above, an optical transceiver module for transmitting an optical signal according to the present invention is disclosed. The optical transceiver module includes a receiver, a clock data recovery circuit and a controller. The receiver receives the optical signal and converts the optical signal into an electric signal. The clock data recovery circuit receives the electric signal and recovers the clock and data of the electric signal. The controller is electrically connected with and monitors the clock data recovery circuit.

To achieve the above, a control method of an optical transceiver module, which applied the above-mentioned optical transceiver module for transmitting an optical signal according to the present invention is disclosed. The control method includes the steps of: receiving the optical signal and converting the optical signal into an electric signal by a receiver, receiving the electric signal and recovering the clock and data of the electric signal by a clock data recovery circuit; and monitoring the clock data recovery circuit by a controller.

As mentioned above, because the present invention provides the clock data recovery circuit, the clock and the data of the electric signal can be recovered during high-frequency transmission. Comparing with the prior art, an optical transceiver module and a control method thereof according to the present invention can accurately receive and process the optical signal, and especially recover the clock and the data of the electric signal especially during high-frequency transmission.

### BRIEF DESCRIPTION OF THE DRAWINGS

The present invention will become more fully understood from the detailed description given herein below illustration only, and thus are not limitative of the present invention, and wherein:

FIG. 1 is a block diagram showing a conventional optical transceiver module;

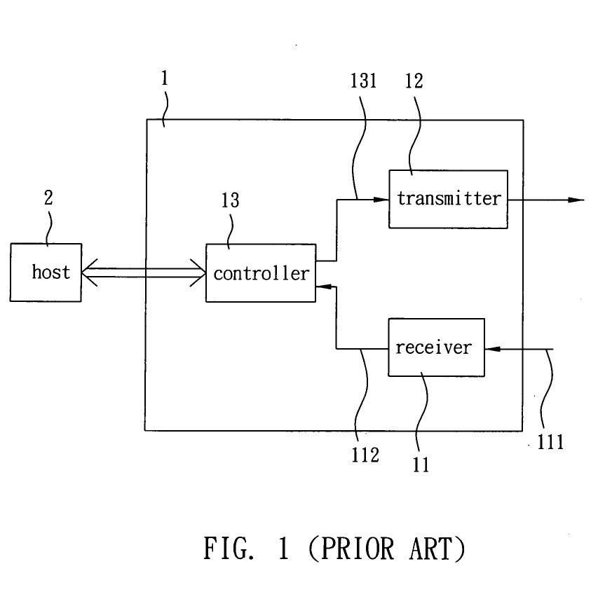

FIG. 2 is a block diagram showing an optical transceiver module according to a preferred embodiment of the present invention; and

FIG. 3 is a flow chart showing a control method of an optical transceiver module according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

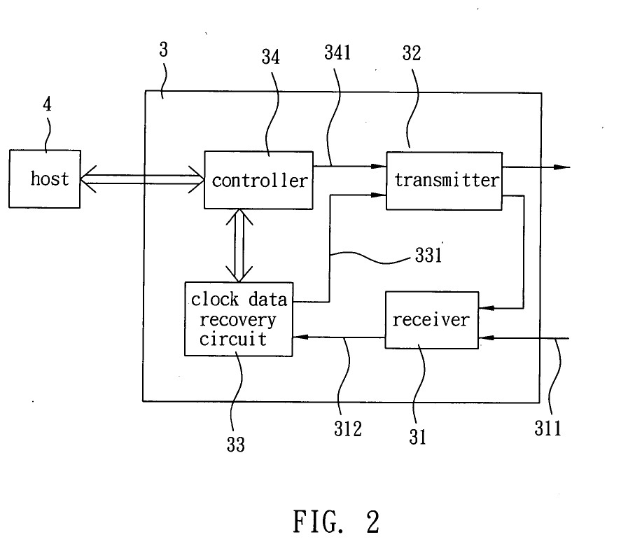

As shown in FIG. 2, an optical transceiver module 3 according to a preferred embodiment of the present invention includes a receiver 31, a transmitter 32, a clock data recovery circuit 33 and a controller 34.

The receiver 31 receives an optical signal 311 and converts the optical signal 311 into an electric signal 312. The clock data recovery circuit 33 receives the electric signal 312 and recovers the clock and the data of the electric signal 312. The controller 34 is electrically connected with and monitors the clock data recovery circuit 33.

The controller 34 starts a loop test of the clock data recovery circuit 33, so that the optical transceiver module 3 can directly transmit data from the transmitter 32 to the receiver 31, and determine if the data is transmitted accurately. Also, the controller 34 turns on a low power state of the clock data recovery circuit 33 so as to save power consumption of the clock data recovery circuit 33. In this embodiment, the controller 34 monitors the clock data recovery circuit 33 via a serial peripheral interface (SPI) or an inter-integrated circuit (12C) interface. Further, the controller 34 may also communicate with a host 4 via a general purpose I/O (GPIO) interface.

In order to monitor if the optical transceiver module 3 is operated normally, the controller 34 monitors the locked state of the clock of the clock data recovery circuit 33 so as to ensure the clock of the electric signal 312 can be accurately recovered. In this embodiment, the data transfer rate of the optical signal 311 may be greater than 10 Gbps. In addition, the controller 34 may also monitor a temperature, a bias current, a working voltage, a power of the receiver 31, or a power of the transmitter 32 of the optical transceiver module 3.

These monitoring results are stored in the register (not shown) of the controller 34. When the monitoring results exceed a normally predetermined range, the controller 34 generates and transmits an interrupt request (IRQ) to the host 4 so as to request the host 4 to react to the abnormal state of the optical transceiver module 3.

In addition, the controller 34 may directly determine the temperature, the bias current, the working voltage, the power of the receiver 31, or the power of the transmitter 32 of the optical transceiver module 3 at first. Alternately, the controller 34 may determine the locked state of clock of the clock data recovery circuit 33 firstly. When the monitoring results exceed a normally predetermined range, the corresponding control symbols in the memory of the controller 34 will be set. Then, the controller 34 generates and transmits an interrupt request (IRQ) to the host 4 in accordance with the state of the control symbols, and requests the host 4 to react to the abnormal state of the optical transceiver module 3.

For example, when the bias current, the working voltage, the power of the receiver 31, or the power of the transmitter 32 of the optical transceiver module 3 is too low, the controller 34 generates and transmits an interrupt request (IRQ) to the host 4. The host 4 requests a power supply to provide a higher power to the optical transceiver module 3. In addition, the controller 34 may also react to the abnormal condition by itself. For example, the controller 34 may turn on a fan (not shown) mounted to the optical transceiver module 3 for thermal dissipation when the temperature of the optical transceiver module 3 is too high. If the locked state of the clock data recovery circuit 33 is incorrect, the controller 34 generates and transmits an interrupt request (IRQ) to the host 4 after monitoring. The host 4 may request the host to transmit data one more time.

The clock data recovery circuit 33 may generate a fixed frequency signal 331 to the transmitter 32 for the transmission of a data signal 341 received from the host 4.

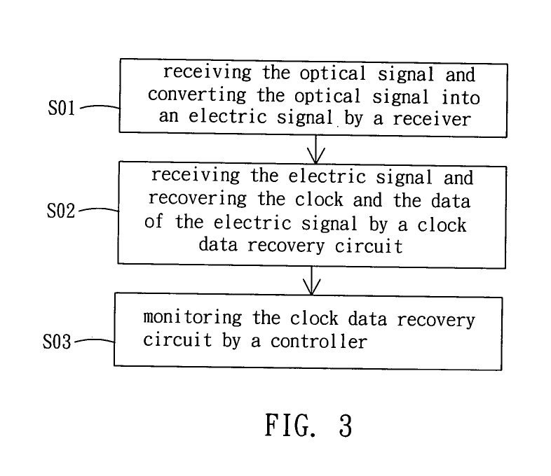

As shown in FIG. 3, a control method of an optical transceiver module, which applied the optical transceiver module in FIG. 2 for transmitting an optical signal according to a preferred embodiment of the present invention is disclosed. The control method includes the following steps. In step S01, receiving the optical signal 311 and converting the optical signal 311 into an electric signal 312 by a receiver 31. In step S02, receiving the electric signal 312 and recovering the clock and the data of the electric signal 312 by a clock data recovery circuit 33. In step S03, monitoring the clock data recovery circuit 33 by a controller 34.

Because the control method of the optical transceiver module is described hereinabove, detailed descriptions thereof will be omitted.

In summary, because the present invention provides the clock data recovery circuit, the clock and the data of the electric signal can be recovered during high-frequency transmission. Comparing with the prior art, an optical transceiver module and a control method thereof according to the present invention can accurately receive and process the optical signal, and recover the clock and the data of the electric signal especially during high-frequency transmission.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. An optical transceiver module for transmitting an optical signal, comprising:
a receiver receiving the optical signal and converting the optical signal into an electric signal;
a clock data recovery circuit receiving the electric signal and recovering the clock and the data of the electric signal; and
a controller electrically connected with and monitoring the clock data recovery circuit.

2. The optical transceiver module according to claim 1, wherein the controller monitors a locked state of the clock of the clock data recovery circuit.

3. The optical transceiver module according to claim 1, wherein the controller starts a loop test of the clock data recovery circuit.

4. The optical transceiver module according to claim 1, wherein the controller turns on a low power state of the clock data recovery circuit.

5. The optical transceiver module according to claim 1, wherein the controller monitors a temperature, a bias current, a working voltage, or a power of the optical transceiver module.

6. The optical transceiver module according to claim 1, wherein the optical signal has a data transfer rate which is greater than 10 Gbps.

7. The optical transceiver module according to claim 1, further comprising a transmitter, wherein the controller monitors a power of the transmitter.

8. The optical transceiver module according to claim 1, wherein the controller monitors the clock data recovery circuit via a serial peripheral interface (SPI) or an inter-integrated circuit interface.

9. The optical transceiver module according to claim 1, wherein the controller is communicated with a host via a general purpose I/O interface.

10. A control method of an optical transceiver module for transmitting an optical signal, comprising steps of:
receiving the optical signal and converting the optical signal into an electric signal by a receiver,
receiving the electric signal and recovering clock and data of the electric signal by a clock data recovery circuit; and
monitoring the clock data recovery circuit by a controller.

11. The control method according to claim 10, further comprising a step of monitoring a locked state of the clock of the clock data recovery circuit by the controller.

12. The control method according to claim 10, further comprising a step of starting a loop test of the clock data recovery circuit by the controller.

13. The control method according to claim 10, further comprising a step of turning on a low power state of the clock data recovery circuit by the controller.

14. The control method according to claim 10, further comprising a step of monitoring a temperature, a bias current, a working voltage, or a power of the optical transceiver module by the controller.

15. The control method according to claim 10, wherein the optical signal has a data transfer rate which is greater than 10 Gbps.

16. The control method according to claim 10, further comprising a step of monitoring a power of a transmitter by the controller.

17. The control method according to claim 10, wherein the controller monitors the clock data recovery circuit via a serial peripheral interface (SPI) or an inter-integrated circuit interface.

18. The control method according to claim 10, wherein the controller is communicated with a host via a general purpose I/O interface.
